(19) United States
(12) Patent Application Publication
(10) Pub. No.: US 2026/0045784 A1
(43) Pub. Date: Feb. 12, 2026

(54) Earth leakage breaker systems with leakage current limiting function

(71) Applicant: VISION TECH Corporation, Busan (KR)

(72) Inventor: Ho Seok LEE, Seoul (KR)

(73) Assignee: VISION TECH Corporation, Busan (KR)

(21) Appl. No.: 19/051,199

(22) Filed: Feb. 12, 2025

(30) Foreign Application Priority Data
Aug. 8, 2024 (KR) 10-2024-0105839

(51) Int. Cl. H02H 3/16; H01H 71/02; H01H 71/08; H02H 3/02; H02H 9/08

(52) U.S. Cl. CPC H02H 3/167; H01H 71/0207; H01H 71/08; H02H 3/025; H02H 9/08

(57) ABSTRACT

The present disclosure relates to an earth leakage breaker system with a leakage current limiting function, which can enhance leakage current limiting efficiency by additionally expanding areas of an input-side leakage current limiting unit and an output-side leakage current limiting unit that perform the leakage current limiting function and can ensure stable leakage current limiting operation by implementing the input-side leakage current limiting unit and the output-side leakage current limiting unit with enhanced corrosion resistance.

### CROSS-REFERENCE TO RELATED APPLICATION(S)

This application claims priority from Korean Patent Application No. 10-2024-0105839, filed on Aug. 8, 2024, in the Korean Intellectual Property Office, the disclosure of which is incorporated herein by reference in its entirety.

### BACKGROUND

### 1. Field

The following description relates to an earth leakage breaker system that disconnects a power source when an unbalanced current of the power source caused by a leakage current exceeds a predetermined value, and more particularly, to an earth leakage breaker system with a leakage current limiting function.

### 2. Description of Related Art

Korean Patent Registration No. 10-2519689 (published on Apr. 7, 2023) previously filed and registered by the applicant of the present disclosure discloses an earth leakage breaker system with a leakage current limiting function, in which leakage current limiting units are implemented at both ends of an earth leakage breaker unit, thereby providing a leakage current limiting function on each of the input terminal and the output terminal, increasing leakage current limiting efficiency, and more effectively preventing electric shock accidents.

The present inventor has studied an improved earth leakage breaker system, which enhances leakage current limiting efficiency by additionally expanding areas of an input-side leakage current limiting unit and an output-side leakage current limiting unit that perform the leakage current limiting function, and ensures stable leakage current limiting operation by implementing the input-side leakage current limiting unit and the output-side leakage current limiting unit with enhanced corrosion resistance.

### SUMMARY

The present disclosure is directed to providing an earth leakage breaker system with a leakage current limiting function, in which areas of an input-side leakage current limiting unit and an output-side leakage current limiting unit that perform the leakage current limiting function are additionally expanded and the output-side leakage current limiting unit is implemented to ensure corrosion resistance.

One aspect of the present provides an earth leakage breaker system with a leakage current limiting function, which includes an input terminal to which an input-side wire is connected, an output terminal to which an output-side wire is connected, an earth leakage breaker unit of which both ends are connected to the input terminal and the output terminal connected and which disconnects an electrical connection between the input terminal and the output terminal when an overcurrent flows, an input-side leakage current limiting unit that is disposed between the input terminal and the earth leakage breaker unit to limit an input-side leakage current and includes an input-side conductor area expansion plate which is electrically connected to an input-side ground terminal and expands a conductor area of the input-side ground terminal to limit a leakage current, and the output-side leakage current limiting unit that is disposed between the earth leakage breaker unit and the output terminal to limit an output-side leakage current and includes an output-side conductor area expansion plate which is electrically connected to an output-side ground terminal and expands a conductor area of the output-side ground terminal to limit a leakage current, wherein the input-side conductor area expansion plate includes an input-side first conductor area expansion plate, to which the input-side ground terminal is electrically connected and which expands a conductor area at the input-side ground terminal and an input-side second conductor area expansion plate, which is stacked on an upper portion or lower portion of the input-side first conductor area expansion plate and further expands the conductor area at the input-side ground terminal.

The output-side conductor area expansion plate may include an output-side first conductor area expansion plate, to which the output-side ground terminal is electrically connected and which expands a conductor area at the output-side ground terminal and an output-side second conductor area expansion plate, which is stacked on an upper portion or lower portion of the output-side first conductor area expansion plate and further expands the conductor area at the output-side ground terminal.

The input-side conductor area expansion plate and the output-side conductor area expansion plate may each be implemented with a conductor including a corrosion-resistant carbon steel or stainless steel material.

The earth leakage breaker unit may include an earth leakage breaker switch that blocks the electrical connection between the input terminal and the output terminal.

The earth leakage breaker switch may be implemented to be protected by a silicone film.

The earth leakage breaker unit may further include an overcurrent detection unit which detects an overcurrent by measuring whether an unbalanced current of a power source caused by a leakage current exceeds a predetermined value, and a switch driver which is driven when the overcurrent is detected by the overcurrent detection unit and controls switching of the earth leakage breaker switch.

The earth leakage breaker system with a leakage current limiting function may further include an outer case having a grid-type storage groove, which accommodates the input-side leakage current limiting unit and the output-side leakage current limiting unit, which are arranged at both ends of the earth leakage breaker unit, and the earth leakage breaker unit in separate storage spaces so as to prevent the input-side leakage current limiting unit and the output-side leakage current limiting unit from having an electrical effect on the earth leakage blocking unit.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is an exterior perspective view illustrating a configuration of an earth leakage breaker system with a leakage current limiting function according to an embodiment of the present disclosure;

FIG. 2 is an exploded perspective view illustrating a configuration of an earth leakage breaker system with a leakage current limiting function according to an embodiment of the present disclosure; and

FIG. 3 is a block diagram illustrating a configuration of a leakage current blocking circuit in an earth leakage breaker system with a leakage current limiting function according to an embodiment of the present disclosure.

### DETAILED DESCRIPTION

Hereinafter, the present disclosure will be described in detail so that those skilled in the art may easily understand and reproduce the present disclosure through exemplary embodiments described with reference to the accompanying drawings. Although specific embodiments are illustrated in the drawings and related detailed descriptions are made, the embodiments and descriptions are not intended to limit various embodiments of the present disclosure to any particular form.

In the description of the present disclosure, when it is determined that the detailed description of related widely known functions or configurations may make the subject matter of the embodiments of the present disclosure unclear, the detailed description will be omitted.

It should be understood that, when it is mentioned that a first component is “connected” or “coupled” to a second component, the first component may be directly connected or coupled to the second component, or a third component may be present between the first component and the second component.

On the other hand, it should be understood that, when a first component is “directly connected” or “directly coupled” to a second component, a third component is not present therebetween.

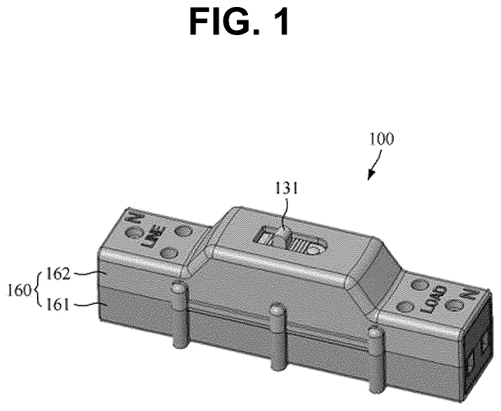

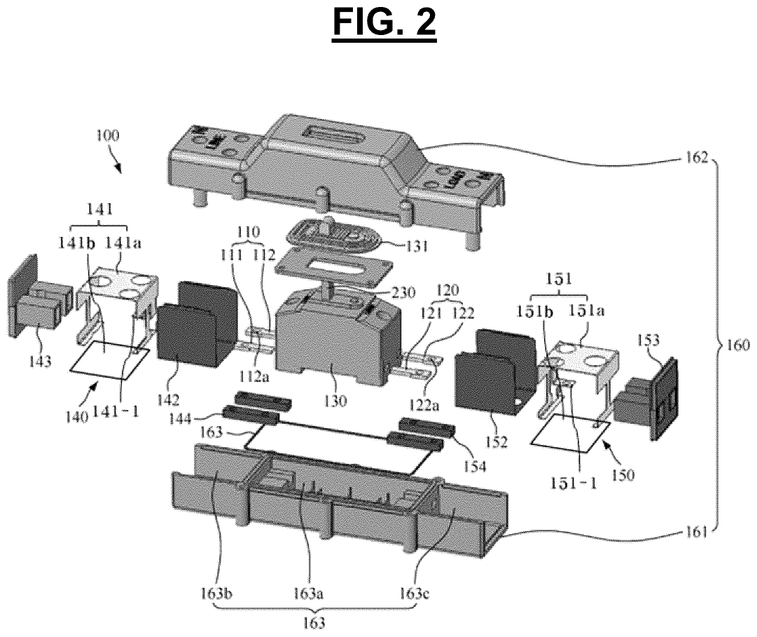

FIG. 1 is an exterior perspective view illustrating a configuration of an earth leakage breaker system with a leakage current limiting function according to an embodiment of the present disclosure, and FIG. 2 is an exploded perspective view illustrating a configuration of an earth leakage breaker system with a leakage current limiting function according to an embodiment of the present disclosure, which can be applied to an earth leakage breaker system or a circuit breaker system. Meanwhile, the drawings illustrate a 3-phase 3-wire type earth leakage breaker system, but it can be applied to a 3-phase 4-wire or single-phase type earth leakage breaker system.

As illustrated in FIGS. 1 and 2, the earth leakage breaker system 100 with a leakage current limiting function according to the embodiment includes an input terminal 110, an output terminal 120, an earth leakage breaker unit 130, an input-side leakage current limiting unit 140, and an output-side leakage current limiting unit 150.

The input terminal 110 is connected to an input-side wire. The input terminal 110 includes a phase voltage line input terminal 111 that will be connected to a phase voltage line (R phase or S phase or T phase) of the input-side wire, and an input-side ground terminal 112 that will be connected to an input-side ground line (G phase).

In this case, for the 3-phase 4-wire type, an input-side neutral line (N phase) may be used instead of the input-side ground line (G phase), a neutral line input terminal may be used instead of the input-side ground terminal 112 so that the input-side neutral line (N phase) is connected to the neutral line input terminal.

The output terminal 120 is connected to an output-side wire. The output terminal 120 includes a phase voltage line output terminal 121 that will be connected to the phase voltage line (R phase or S phase or T phase) of the output-side wire, and an output-side ground terminal 122 that will be connected to the input-side ground line (G phase).

In this case, for the 3-phase 4-wire type, an output-side neutral line (N phase) may be used instead of the input-side ground line (G phase), and a neutral line output terminal may be used instead of the output-side ground terminal 122 so that the output-side neutral line (N phase) is connected to the neutral line output terminal.

The input terminal 110 and the output terminal 120 are connected to both ends of the earth leakage breaker unit 130 that disconnects an electrical connection between the input terminal 110 and the output terminal 120 when an overcurrent flows. Inside the earth leakage breaker unit 130, an earth leakage breaker circuit 200 is mounted to disconnect a power source when an unbalanced current of the power source caused by a leakage current exceeds a predetermined value.

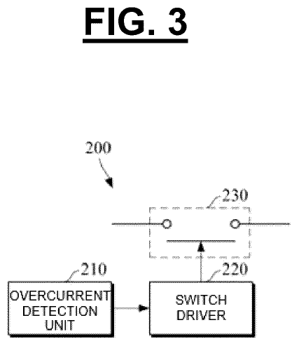

FIG. 3 is a block diagram illustrating a configuration of a leakage current blocking circuit in an earth leakage breaker system with leakage current limiting according to an embodiment of the present disclosure. The earth leakage breaker circuit 200 according to the embodiment includes an overcurrent detection unit 210, a switch driver 220, and an earth leakage breaker switch 230.

The overcurrent detection unit 210 detects an overcurrent by measuring whether an unbalanced current of the power source caused by a leakage current exceeds a predetermined value. The switch driver 220 is driven when the overcurrent is detected by the overcurrent detection unit 210 and controls the switching of the earth leakage breaker switch 230.

The earth leakage breaker switch 230 blocks an electrical connection between the input terminal 110 and the output terminal 120. In this case, the earth leakage breaker switch 230 may be implemented to be protected by a silicone film, and thus moisture does not flow into the earth leakage breaker unit 130.

The input-side leakage current limiting unit 140 is disposed between the input terminal 110 and the earth leakage breaker unit 130 to limit an input-side leakage current and includes an input-side conductor area expansion plate 141 which is electrically connected to the input-side ground terminal 112 and expands a conductor area of the input-side ground terminal 112 to limit leakage current.

In this case, the input-side conductor area expansion plate 141 may include an input-side first conductor area expansion plate 141a, to which the input-side ground terminal 112 is electrically connected and which expands a conductor area at the input-side ground terminal, and an input-side second conductor area expansion plate 141b, which is stacked on an upper portion or lower portion of the input-side first conductor area expansion plate 141a and further expands the conductor area at the input-side ground terminal.

Referring to FIG. 2, it can be seen that the input-side second conductor area expansion plate 141b is stacked on the lower portion of the input-side first conductor area expansion plate 141a. In FIG. 2, reference numerals 141-1 and 112a represent a connection unit in which the input-side conductor area expansion plate 141 and the input-side ground terminal 112 are electrically connected to each other.

Meanwhile, reference numeral 142 is an insulating case for supporting the input-side conductor area expansion plate 141, reference numeral 143 is an input terminal mounting part in which the input terminal 110 is accommodated and mounted, and reference numeral 144 is an insulating support part that supports a lower portion of the input terminal 110.

The output-side leakage current limiting unit 150 is disposed between the earth leakage breaker unit 130 and the output terminal 120 to limit an output-side leakage current and includes an output-side conductor area expansion plate 151 which is electrically connected to the output-side ground terminal 122 and expands a conductor area of the output-side ground terminal 122 to limit leakage current.

In this case, the output-side conductor area expansion plate 151 may include an output-side first conductor area expansion plate 151a, to which the output-side ground terminal 122 is electrically connected and which expands a conductor area at the output-side ground terminal, and an output-side second conductor area expansion plate 151b, which is stacked on an upper portion or lower portion of the output-side first conductor area expansion plate 151a and further expands the conductor area at the output-side ground terminal.

Referring to FIG. 2, it can be seen the output-side second conductor area expansion plate 151b is stacked on a lower portion of the output-side first conductor area expansion plate 151a. In FIG. 2, reference numerals 151-1 and 122a represent a connection unit in which the output-side conductor area expansion plate 151 and the output-side ground terminal 122 are electrically connected to each other.

Meanwhile, reference numeral 152 is an insulating case for supporting the output-side conductor area expansion plate 151, reference numeral 153 is an output terminal mounting part in which the output terminal 120 is accommodated and mounted, and reference numeral 154 is an insulating support part that supports a lower portion of the output terminal 120.

By this implementation, according to the present disclosure, the conductor area of the input-side ground terminal 112 is expanded by the input-side conductor area expansion plate 141, and thus the conductor area becomes larger than a conductor area of the phase voltage line input terminal 111.

Also, according to the present disclosure, the conductor area of the output-side ground terminal 122 is expanded by the output-side conductor area expansion plate 151, and thus the conductor area becomes greater than a conductor area of the phase voltage line output terminal 121.

The leakage current is limited by a difference in area between the phase voltage line input terminal 111 and the input-side ground terminal 112, which have different areas, and a difference in area between the phase voltage line output terminal 121 and the output-side ground terminal 122, which have different areas.

The greater a difference in area between two electrodes, the smaller leakage current becomes. As the leakage current decreases, the risk of electric shock becomes lower, thereby enabling a leakage current limiting function that eliminates concerns about electric shock.

The reason for this, as disclosed in Korean Patent Registration No. 10-2519689 (published on Apr. 7, 2023) described in the related art field and Korean Patent Registration No. 10-1404806 (May 30, 2014), etc. described in the related art of this registered patent, is that a leakage current gradually decreases as an area of a flat plate-shaped conductor (corresponding to the input-side ground terminal and the output-side ground terminal of the present disclosure) connected to a negative terminal becomes greater than an area of a flat plate-shaped conductor (corresponding to the phase voltage line input terminal and the phase voltage line output terminal of the present disclosure) connected to a positive terminal of a power source.

Accordingly, the earth leakage breaker system with a leakage current limiting function may enhance leakage current limiting efficiency by additionally expanding an area of an input-side leakage current limiting unit and an output-side leakage current limiting unit that perform the leakage current limiting function.

Meanwhile, according to an additional aspect of the present disclosure, the input-side conductor area expansion plate 141 and the output-side conductor area expansion plate 151 may each be implemented with a conductor including a corrosion-resistant carbon steel or stainless steel material.

Carbon steel is an alloy of iron and carbon, which is more resistant to corrosion compared to regular steel, while stainless steel is an alloy of steel containing chromium, which does not experience corrosion at all.

By this implementation, according to the present disclosure, stable leakage current limiting operation may be ensured by implementing the input-side leakage current limiting unit and the output-side leakage current limiting unit with enhanced corrosion resistance.

Meanwhile, according to an additional aspect of the present disclosure, the earth leakage breaker system 100 with a leakage current limiting function may further include an outer case 160. The outer case 160 includes an outer case base 161 and an outer case cover 162, which are coupled to each other. Reference numeral 163 is a rubber packing that seals the earth leakage breaker unit 130 to prevent moisture from entering.

In this case, the outer case 160 may be provided with a grid-type storage groove 163. In this case, the grid-type storage groove 163 may be formed in the outer case base 161, and the earth leakage breaker unit 130, the input-side leakage current limiting unit 140 and the output-side leakage current limiting unit 150, which are disposed at both ends of the earth leakage breaker unit, are accommodated in separate storage spaces 163a, 163b, and 163c.

Accordingly, the input-side leakage current limiting unit 140 and the output-side leakage current limiting unit 150 are electrically isolated from the earth leakage breaker unit 130 by the grid-type storage groove 163 formed in the outer case 160, thereby preventing the input-side leakage current limiting unit 140 and the output-side leakage current limiting unit 150 from having an electrical effect on the earth leakage breaker unit 130.

According to the present disclosure, an earth leakage breaker system with a leakage current limiting function can enhance leakage current limiting efficiency by additionally expanding areas of an input-side leakage current limiting unit and an output-side leakage current limiting unit that perform the leakage current limiting function and can ensure stable leakage current limiting operation by implementing the input-side leakage current limiting unit and the output-side leakage current limiting unit with enhanced corrosion resistance.

Various embodiments disclosed in the present specification and the accompanying drawings are merely presented as specific examples to help understanding and are not intended to limit the scope of various embodiments of the present disclosure.

Thus, it should be interpreted that the scope of various embodiments of the present disclosure includes all changes or modifications derived based on the technical spirit of various embodiments of the present disclosure in addition to the embodiments described herein.

The present disclosure can be industrially utilized in the technical field related to earth leakage breaker systems, such as a circuit breaker system or an earth leakage breaker system, and in the field of their applications.

What is claimed is:

1. An earth leakage breaker system with a leakage current limiting function, comprising:
an input terminal to which an input-side wire is connected;
an output terminal to which an output-side wire is connected;
an earth leakage breaker unit of which both ends are connected to the input terminal and the output terminal and which disconnects an electrical connection between the input terminal and the output terminal when an overcurrent flows;
an input-side leakage current limiting unit that is disposed between the input terminal and the earth leakage breaker unit to limit an input-side leakage current and includes an input-side conductor area expansion plate which is electrically connected to an input-side ground terminal and expands a conductor area of the input-side ground terminal to limit a leakage current; and
an output-side leakage current limiting unit that is disposed between the earth leakage breaker unit and the output terminal to limit an output-side leakage current and includes an output-side conductor area expansion plate which is electrically connected to an output-side ground terminal and expands a conductor area of the output-side ground terminal to limit a leakage current,
wherein the input-side conductor area expansion plate includes:
an input-side first conductor area expansion plate to which the input-side ground terminal is electrically connected and which expands a conductor area at the input-side ground terminal; and
an input-side second conductor area expansion plate, which is stacked on an upper portion or lower portion of the input-side first conductor area expansion plate and further expands the conductor area at the input-side ground terminal.

2. The earth leakage breaker system of claim 1, wherein the output-side conductor area expansion plate includes:
an output-side first conductor area expansion plate to which the output-side ground terminal is electrically connected and which expands a conductor area at the output-side ground terminal; and
an output-side second conductor area expansion plate which is stacked on an upper portion or lower portion of the output-side first conductor area expansion plate and further expands the conductor area at the output-side ground terminal.

3. The earth leakage breaker system of claim 1, wherein the input-side conductor area expansion plate and the output-side conductor area expansion plate is each implemented with a conductor including a corrosion-resistant carbon steel or stainless steel material.

4. The earth leakage breaker system of claim 3, wherein the earth leakage breaker unit includes an earth leakage breaker switch that blocks the electrical connection between the input terminal and the output terminal.

5. The earth leakage breaker system of claim 4, wherein the earth leakage breaker switch is protected by a silicone film.

6. The earth leakage breaker system with the leakage current limiting function of claim 4, wherein the earth leakage breaker unit further includes:
an overcurrent detection unit which detects an overcurrent by measuring whether an unbalanced current of a power source caused by a leakage current exceeds a predetermined value; and
a switch driver which is driven when the overcurrent is detected by the overcurrent detection unit and controls switching of the earth leakage breaker switch.

7. The earth leakage breaker system of claim 4, further comprising an outer case having a grid-type storage groove which accommodates the input-side leakage current limiting unit and the output-side leakage current limiting unit, which are disposed at both ends of the earth leakage breaker unit, and the earth leakage breaker unit in separate storage spaces so as to prevent the input-side leakage current limiting unit and the output-side leakage current limiting unit from having an electrical effect on the earth leakage blocking unit.
